(19) United States
(12) Patent Application Publication
(10) Pub. No.: US 2006/0034316 A1
(43) Pub. Date: Feb. 16, 2006

(54) Energy based information transfer methodology

(76) Inventors: Jeyhan Karaoguz, Irvine, CA (US); Nambirajan Seshadri, Irvine, CA (US); James D. Bennett, San Clemente, CA (US)

Correspondence Address: MCANDREWS HELD & MALLOY, LTD, 500 WEST MADISON STREET, SUITE 3400, CHICAGO, IL, 60661, US

(21) Appl. No.: 11/093,157

(22) Filed: Mar. 29, 2005

Related U.S. Application Data
(60) Provisional application No. 60/601,360, filed on Aug. 13, 2004.

(51) Int. Cl. H04J 3/22; H04J 3/16; H04L 12/26; H04J 1/16; H04J 3/14; H04L 1/00

(52) U.S. Cl. 370/437; 370/311; 370/465

(57) ABSTRACT

A system and method for determining an information communication methodology based on energy requirements. Various aspects of the present invention provide a method that comprises identifying a plurality of information communication strategies that may be utilized to communicate information (e.g., one or more units of information). A communication strategy identification module may perform such identification. Respective amounts of energy to communicate the information may be estimated for at least a portion of the identified plurality of information communication strategies. A communication energy estimation module may perform such estimation. An information communication strategy may be selected from the identified plurality of information communication strategies based, at least in part, on the estimated respective amounts of energy. A communication strategy selection module may perform such selection.

### CROSS-REFERENCE TO RELATED APPLICATIONS/INCORPORATION BY REFERENCE

This patent application is related to and claims priority from provisional patent application Ser. No. 60/601,360, filed Aug. 13, 2004, and titled “ENERGY BASED INFORMATION TRANSFER STRATEGY,” the contents of which are hereby incorporated herein by reference in their entirety. This patent application is related to U.S. patent application Ser. No. ______, filed concurrently herewith, entitled “ENERGY BASED COMMUNICATION PATH SELECTION” (Attorney Docket No. 16051 US02).

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Various communication systems provide for information communication according to any of a large variety of respective information communication strategies. For example and without limitation, characteristics of various information communication strategies may comprise information transfer rate (e.g., data rate), transmission power, signal processing power, communication protocol, encoding/decoding strategy, encryption/decryption strategy, compression/decompression strategy, number of antennas, communication medium, modulation technique, etc.

Various information communication strategies may utilize varying respective amounts of energy. In an exemplary scenario, two information communication strategies that comprise communicating with identical transmission power levels may comprise utilizing substantially different amounts of energy for information communication. Overall energy consumption may depend on any of a variety of factors, including but not limited to, transmission power, data rate, signal processing activity, total amount of data, quality goals, communication environment characteristics, data retransmission activity, etc.

Various communication systems have relatively finite energy supplies. For example, various communication systems may receive operational energy from batteries. Such communication systems may also have static or dynamic communication quality constraints. In various scenarios, energy utilization and communication quality may be adversely related.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method for determining an information communication methodology (or strategy) based on energy requirements, substantially as shown in and/or described in connection with at least one of the figures, as set forth more completely in the claims. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 shows a flow diagram of an exemplary method for determining an information communication strategy, in accordance with various aspects of the present invention.

FIG. 2 shows a flow diagram of an exemplary method for determining an information communication strategy, in accordance with various aspects of the present invention.

FIG. 3 is a drawing showing a block diagram of an exemplary communication system for determining an information communication strategy, in accordance with various aspects of the present invention.

### DETAILED DESCRIPTION OF THE INVENTION

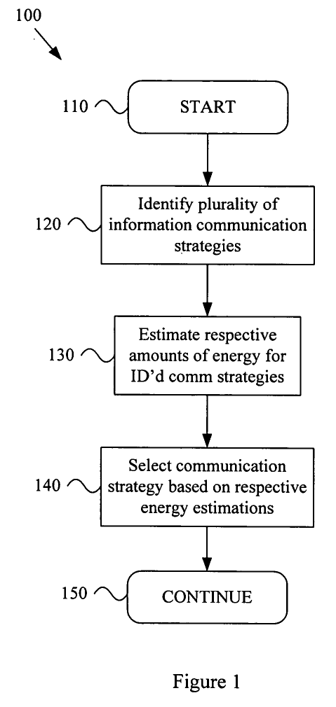

FIG. 1 shows a flow diagram of an exemplary method 100 for determining an information communication methodology (which may also be referred to herein as a “communication strategy”), in accordance with various aspects of the present invention. The exemplary method 100 may, for example, be implemented in any of a variety of communication systems. For example and without limitation, such a communication system may comprise characteristic of a portable or stationary communication system. Such a communication system may, for example, receive electrical energy from a relatively finite energy source (e.g., a battery) or a relatively infinite energy source (e.g., from a wall outlet). Such a communication system may communicate any of a variety of information types (e.g., audio information, video information, data information, general multi-media information etc.). Accordingly, the scope of various aspects of the present invention should not be limited by characteristics of any particular communication system that may implement the exemplary method 100, or any method or functionality discussed herein.

The exemplary method 100 may begin at step 110. The exemplary method 100 may begin for any of a large variety of reasons. For example and without limitation, the method 100 may begin in response to a command to begin, for example originating at a user or other system. Also for example, the method 100 may begin automatically upon system start-up, power-up or reset. Additionally, the method 100 may begin upon receipt of an indication that a communication is to occur (e.g., an outgoing communication or an incoming communication). Further for example, the method 100 may begin in response to a detected operating condition (e.g., a power supply condition, communication link condition, etc.). Accordingly, the scope of various aspects of the present invention should not be limited by characteristics of any particular initiating cause or condition.

The exemplary method 100 may, at step 120, comprise identifying a plurality of information communication strategies that may be utilized to communicate information with one or more other communication systems.

Such information may, for example, comprise one or more units of information, where a “unit of information” is some quantifiable amount of information. For example and without limitation, a unit of information may be a packet, message, song, program, music video, movie, etc. Further for example, a unit of information may be a quantifiable portion of a non-quantifiable amount of information (e.g., a television channel or telephone conversation). Such information may comprise characteristics of any of a variety of types of information (e.g., textual, graphical, multi-media, video, audio, pictorial, general data, etc.). The scope of various aspects of the present invention should not be limited by characteristics of a particular type of information or by any arbitrary notion of what a unit of such information may comprise.

An information communication strategy may comprise any of any of a large variety of information communication characteristics. For example and without limitation, one of more (e.g., a first portion) of the identified plurality of information communication strategies may comprise a connectionless communication strategy, and one or more (e.g., a second portion) of the identified plurality of information communication strategies may comprise a connection-oriented communication strategy. In a non-limiting exemplary scenario, a first information communication strategy may comprise characteristics of Internet data packet communication, and a second information communication strategy may comprise characteristics of full-duplex communication over an allocated channel.

Also for example, one or more of the identified plurality of information communication strategies may comprise communicating information at a first data rate, and one or more of the identified plurality of information communication strategies may comprise communicating information at a second data rate. Various types of communication may, for example, correspond with different data transfer rates or transfer rate ranges. In a non-limiting exemplary scenario, a first information communication strategy (e.g., a text messaging scenario where the amount of information is relatively low and/or real-time data transfer that may not be critical) may comprise communicating information at a relatively low data rate. Also in the exemplary scenario, a second information communication strategy (e.g., a real-time audio or video communication scenario where the amount of information is relatively high and/or real-time data transfer rate is important) may comprise communicating information at a relatively high data rate.

Further for example, one or more of the identified plurality of information communication strategies may comprise transmitting information at a first transmission power, and a second portion of the identified plurality of information communication strategies may comprise transmitting information at a second transmission power. Various types of communication may, for example, correspond to different transmission power. For example and without limitation, a digital communication strategy may generally correspond to lower transmission power than an analog communication strategy.

In a non-limiting exemplary scenario, a first information communication strategy (e.g., a digital communication strategy) may comprise transmitting a signal at a relatively low transmitting power, while a second information communication strategy (e.g., an analog communication strategy) may comprise transmitting a signal at a relatively high transmitting power. In another non-limiting exemplary scenario, a first information communication strategy (e.g., an information communication strategy utilizing error correction encoding) may comprise transmitting a signal at a relatively low transmitting power, while a second information communication strategy (e.g., an information communication strategy that does not utilize error correction encoding) may comprise transmitting a signal at a relatively high transmitting power. In yet another non-limiting exemplary scenario, a first information communication strategy (e.g., an information communication strategy utilizing a plurality of antennas for transmitting, for example, in a MIMO or beam-forming configuration) may comprise transmitting at a relatively low transmitting power, while a second information communication strategy (e.g., an information communication strategy utilizing a single non-directional antenna) may comprise transmitting at a relatively high transmitting power.

Also for example, one or more of the identified plurality of information communication strategies may comprise communicating information over a first communication medium, and one or more of the identified plurality of information communication strategies may comprise communicating information over a second communication medium. Various types of communication may, for example, utilize one or more different communication media. Such communication media may, for example, comprise wired media, tethered optical media, wireless RF media, non-tethered optical media, etc.

Still further for example, one or more of the identified plurality of information communication strategies may comprise modulating information utilizing a first type of modulation, and one or more of the identified plurality of information communication strategies may comprise modulating information utilizing a second type of modulation. Various information communication strategies may, for example, comprise utilizing one or more corresponding modulation techniques. In a non-limiting exemplary scenario, a first information communication strategy may comprise utilizing frequency modulation, and a second information communication strategy may comprise utilizing QPSK modulation. In another non-limiting exemplary scenario, a first information communication strategy may comprise utilizing a spread spectrum modulating technique, while a second information communication strategy may comprise utilizing QAM modulation.

Also for example, one or more of the identified plurality of information communication strategies may comprise communicating information utilizing a first communication protocol, and one or more of the identified plurality of information communication strategies may comprise communicating information utilizing a second communication protocol. Various information communication strategies may, for example, correspond to one or more respective communication protocols. In a non-limiting exemplary scenario, a first information communication strategy may comprise utilizing a contention-based communication protocol, and a second information communication strategy may comprise utilizing a contention-free communication protocol. In another non-limiting exemplary scenario, a first information communication strategy may comprise utilizing a CSMA/CD communication protocol, and a second information communication strategy may comprise utilizing a token-based communication protocol.

Still further for example, one or more of the identified plurality of information communication strategies may comprise utilizing a first communication standard, and one or more of the identified plurality of information communication strategies may comprise utilizing a second communication standard. In a non-limiting exemplary scenario, a first information communication strategy may comprise communicating information utilizing the IEEE 802.11 (WLAN) standard, and a second information communication strategy may comprise communicating information utilizing the Bluetooth standard. In another non-limiting exemplary scenario, a first information communication strategy may comprise communicating information utilizing the IEEE 802.15 (WPAN) standard, and a second information communication strategy may comprise communicating information utilizing the IEEE 802.16 (WMAN) standard. In yet another non-limiting exemplary scenario, a first information communication strategy may comprise communicating information utilizing TCP/IP, and a second information communication strategy may comprise communicating information utilizing UDP/IP.

For example, one or more of the identified plurality of information communication strategies may comprise communicating information utilizing a first number of antennas, and one or more of the identified plurality of information communication strategies may comprise communicating information utilizing a second number of antennas. Various information communication strategies may, for example, utilize different numbers of antennas. In an exemplary scenario, a first information communication strategy may comprise utilizing a single omni-directional antenna, and a second information communication strategy may comprise utilizing a plurality of antennas in a beam-forming configuration. In another exemplary scenario, a first information communication strategy may comprise communicating information utilizing two antennas in a Multiple Input Multiple Output (MIMO) configuration, and a second information communication strategy may comprise communicating information utilizing three antennas in a MIMO configuration.

Also for example, one or more of the identified plurality of information communication strategies may comprise encoding information utilizing a first type of encoding, and one or more of the identified plurality of information communication strategies may comprise encoding information utilizing a second type of encoding. Various information communication strategies may, for example, correspond to one or more respective types of encoding. In a non-limiting exemplary scenario, a first information communication strategy may comprise encoding information with error detection encoding, and a second information communication strategy may comprise encoding information with error correction encoding. In another non-limiting exemplary scenario, a first information communication strategy may comprise communicating information utilizing Viterbi encoding, and a second information communication strategy may comprise communicating information utilizing Reed-Solomon encoding.

Further for example, one or more of the plurality of information communication strategies may comprise utilizing a first type of secure communication technique, and one or more of the identified plurality of information communication strategies may comprise utilizing a second type of secure communication technique. In a non-limiting exemplary scenario, a first information communication strategy may comprise utilizing symmetric encryption, and a second information communication strategy may comprise utilizing asymmetric encryption. In another non-limiting exemplary scenario, a first information communication strategy may comprise utilizing no encryption, and a second information communication strategy may comprise utilizing public/private key encryption.

Still further for example, one or more of the plurality of information communication strategies may comprise utilizing a first type of information compression technique, and one of more of the identified plurality of information communication strategies may comprise utilizing a second type of information compression technique. In a non-limiting exemplary scenario, a first information communication strategy may comprise utilizing MPEG-2 compression, and a second information communication strategy may comprise utilizing MPEG-4, part 10 compression. In another non-limiting exemplary scenario, a first information communication strategy may comprise utilizing MP3 compression, and a second information communication strategy may comprise utilizing AC3 compression. In still another non-limiting scenario, a first information communication strategy may comprise utilizing JPEG compression, and a second information communication strategy may comprise utilizing TIFF compression.

It should be noted that the previously discussed exemplary characteristics of various information communication strategies represent a non-limiting illustrative set of such characteristics. Accordingly, the scope of various aspects of the present invention should not be limited by characteristics of any particular communication strategy, including those discussed above and those not discussed above.

As mentioned previously step 120 may comprise identifying a plurality of information communication strategies that may be utilized to communicate information (e.g., one or more units of information). Step 120 may comprise identifying a plurality of information communication strategies in any of a variety of manners.

For example and without limitation, step 120 may comprise communicating with one or more other communicating systems regarding respective communication capabilities of the various communication systems. In a non-limiting exemplary scenario, a first communication system (e.g., implementing the exemplary method 100) may communicate with a second communication system to determine the communication capabilities of the second communication system, and vice versa. Such communication may, for example and without limitation, comprise communicating information of any of the various communication characteristics discussed previously. For example, the first communication system may communicate with the second communication system to determine information related to data communication rate, transmission/reception power, communication protocols, antenna number, encoding/decoding capability, communication medium access, modulation/demodulation capability, secure communication capability, various signal processing capabilities, etc.

Also for example, step 120 may comprise communicating with a database that comprises information related to the communication capabilities of various communication systems. Such a database may, for example, comprise relatively static information of communication system capability or may, for example, comprise dynamically updated information of communication system capability. For example, such dynamically updated information may comprise information related to current communication network operational status and/or connectivity.

Also for example, step 120 may comprise testing for various communication capabilities. In a non-limiting exemplary scenario, a first communication system (e.g., implementing the exemplary method 100) may attempt to communicate with one or more other communication systems using a variety of communication techniques to determine which communication techniques are effective. For example, a first communication system may, through interaction with a second communication system or database having information related to the second communication system, determine that the second communication system comprises capability to communicate using a particular set of communication protocols, modulation methods and secure communication techniques. The first system may, in such an exemplary scenario, attempt to communicate with the second communication system utilizing any or all of the set of communication protocols, modulation methods and secure communication techniques to determine if each is presently available.

In a non-limiting exemplary scenario, the first communication system may determine that the second communication system should be capable of communicating information utilizing the IEEE 802.11 and IEEE 802.16 communication standards. The first communication system may then attempt to communicate with the second communication system utilizing the IEEE 802.11 and 802.16 standards to determine if an information communication strategy incorporating one or both of such standards is presently feasible.

In another non-limiting exemplary scenario, the first communication system may determine that the second communication system should be capable of communicating utilizing MIMO communication. The first communication system may then attempt to communicate with the second communication system utilizing MIMO communication to determine if an information communication strategy utilizing MIMO communication is presently feasible.

In yet another non-limiting exemplary scenario, the first communication system may determine that the second communication system should be capable of communicating information over the Internet at a particular minimum data rate. The first communication system may then attempt to establish an Internet communication link with the second communication system and communicate data at the particular minimum data rate to determine if an information communication strategy utilizing Internet communication at the minimum data rate is currently feasible.

In general, step 120 may comprise identifying a plurality of information communication strategies that may be utilized to communicate information. Accordingly, the scope of various aspects of the present invention should not be limited by characteristics of any particular manner of identifying a particular information communication strategy.

The exemplary method 100 may, at step 130, comprise estimating respective amounts of energy to communicate the information (e.g., one or more units of the information) for at least a portion of the identified plurality of information communication strategies. Step 130 may comprise estimating respective amounts of energy in any of a variety of manners. Note that the following discussion may generally distinguish between electrical power and electrical energy, which may be viewed as power integrated over an amount of time, an amount of information, an amount of signal processing activity, etc.

For example and without limitation, step 130 may comprise estimating respective amounts of energy for at least a portion of the identified plurality of information communication strategies based at least in part on transmission power. For example, various information communication strategies may utilize a transmitter to transmit information, where the transmitter utilizes a non-negligible amount of electrical power to transmit the information. Additionally, various information communication strategies may comprise transmitting information at different power levels. In a non-limiting exemplary scenario, a first information communication strategy may comprise transmitting data at an output power of 5 Watts, and a second information communication strategy (e.g., utilizing error correction encoding) may comprise transmitting data at an output power of 3 Watts. In a second exemplary scenario, a first information communication strategy may comprise transmitting information at an output power of 2 Watts (e.g., to a relatively distant station), and a second information communication strategy may comprise transmitting information at 0.2 Watts (e.g., to a relatively close communication network node).

Note that in a non-limiting exemplary scenario involving a plurality of transmitters, step 130 may comprise determining and analyzing transmission energy for each of a plurality of transmitters. For example, in a non-limiting exemplary scenario involving up to order-N MIMO communication, step 130 may comprise estimating total transmission energy utilizing one antenna, two antennas, etc., through N antennas to implement the MIMO communications.

Note that step 130 may, in various scenarios, also comprise estimating respective amounts of energy for at least a portion of the identified plurality of information communication strategies based at least in part on reception power. For example, in various scenarios, different communication strategies may comprise utilizing different respective amounts of electrical power in signal reception circuitry. For example, a first information communication strategy (e.g., where the signal being received is relatively strong) may comprise utilizing a relatively low amount of electrical power in a receiver, and a second information communication strategy (e.g., where the signal being received is relatively weak and requires a large degree of amplification) may comprise utilizing a relatively high amount of electrical power.

Also for example, step 130 may comprise estimating respective amounts of energy for at least a portion of the identified plurality of information communication strategies based at least in part on signal processing energy (or power). For example, different communication strategies may require different respective amounts and/or rates of signal processing, which may correspond to different amounts of electrical energy. In an exemplary scenario, a first information communication strategy (e.g., a strategy employing no error correction encoding and no encryption) may comprise utilizing a relatively low amount of electrical energy to perform signal processing, and a second information communication strategy (e.g., a strategy employing error correction encoding, encryption and advanced data compression) may comprise utilizing a relatively high amount of electrical energy to perform signal processing. In another exemplary scenario, a first information communication strategy (e.g., a non-real-time messaging strategy) may comprise utilizing a relatively low amount of electrical power for signal processing, and a second information communication strategy (e.g., a real-time communication strategy requiring relatively fast processing) may comprise utilizing a relatively high amount of electrical power for signal processing.

Further for example, step 130 may comprise estimating respective amounts of energy for at least a portion of the identified plurality of information communication strategies based at least in part on energy required to retransmit information. For example, various information communication strategies may comprise retransmitting different respective amounts of information. In an exemplary scenario, a first information communication strategy (e.g., an information communication strategy utilizing error detection encoding) may comprise utilizing a relatively high amount of electrical energy for retransmitting information, and a second information communication strategy (e.g., an information communication strategy utilizing error correction encoding) may comprise utilizing a relatively low amount of electrical energy for retransmitting information. In another exemplary scenario, a first information communication strategy (e.g., a standard-quality audio communication strategy) may comprise utilizing a relatively low (or no) amount of electrical energy to retransmit information, and a second information communication strategy (e.g., a high-fidelity audio communication strategy) may comprise utilizing a relatively high amount of electrical energy to retransmit information.

Additionally for example, step 130 may comprise estimating respective amounts of energy for at least a portion of the identified plurality of information communication strategies based at least in part on energy required to re-process retransmitted information. For example, as mentioned previously, various information communication strategies may comprise retransmitting at least a portion of transmitted information. Such retransmitted information may correspond to additional signal processing (e.g., at the transmitting system and/or receiving system). Such signal processing may, for example and without limitation, comprise re-encoding/decoding, re-compressing/decompressing, re-encrypting/decrypting, etc.

Step 130 may, for example, comprise estimating respective amounts of energy to communicate information for one or more of the plurality of information communication strategies. Step 130 may, for example and without limitation, comprise estimating respective amounts of energy utilizing any one or combination of the above-mentioned energy considerations (e.g., transmission power, reception power, signal processing energy (or power), amount of data, data rate, encoding and decoding, encrypting and decrypting, compressing and decompressing, reprocessing and retransmitting, etc.). Further, since the above-mentioned energy considerations are merely exemplary, step 130 may comprise utilizing any other communication-related energy considerations that were not discussed previously.

In general, step 130 may comprise estimating respective amounts of energy to communicate information (e.g., one or more units of information) for at least a portion of the identified plurality of information communication strategies (e.g., as identified at step 120). Accordingly, the scope of various aspects of the present invention should not be limited by characteristics of any particular manner of estimating energy that may be utilized to communicate information.

The exemplary method 100 may, at step 140, comprise selecting an information communication strategy (e.g., to utilize to communicate a unit of information) from the identified plurality of information communication strategies (e.g., as identified at step 120) based, at least in part, on the estimated respective amounts of energy (e.g., as determined at step 130). Step 140 may comprise performing such selection in any of a variety of manners, non-limiting illustrative examples of which are provided below.

Step 140 may, for example, comprise selecting an information communication strategy by selecting an information communication strategy with the lowest respective estimated amount of energy. Various information communication strategies may, for example, comprise utilizing different respective amounts of energy to communicate information. In an exemplary scenario, a first information communication strategy (e.g., a relatively slow, low quality strategy) may comprise utilizing a relatively low amount of energy, and a second information communication strategy (e.g., a real-time high-quality strategy) may comprise utilizing a relatively high amount of energy. In the exemplary scenario, if the first information communication strategy has generally acceptable non-energy-related characteristics, step 140 may comprise selecting the first information communication strategy, which utilizes less energy than the second information communication strategy.

Also for example, step 140 may comprise selecting an information communication strategy by selecting an information communication strategy based, at least in part, on one or more communication quality goals. For example and without limitation, such communication quality goals may comprise characteristics related to information transfer speed (e.g., data rate), error rate, amount of noise, general reliability, data accuracy, data resolution, etc. Various quality goals may, for example, be static or may change depending on operating scenario. For example, a real-time communication system may comprise relatively stringent quality goals (e.g., data rate) during normal operation and comprise relatively loose quality goals (e.g., data rate) during power-save operation.

Step 140 may, for example, comprise determining such communication quality goals in any of a variety of manners. For example and without limitation, step 140 may comprise utilizing predetermined quality goals (e.g., stored in local memory or a system database). Also for example, step 140 may comprise communicating with other communication systems to determine quality goals. Further for example, step 140 may comprise communicating with a user to determine quality goals.

In an exemplary scenario, step 140 may comprise selecting an information communication strategy that utilizes the least amount of energy while meeting minimum quality goals. In another exemplary scenario, step 140 may comprise determining an information communication strategy that provides a desired balance between energy consumption and communication quality.

In general, step 140 may comprise selecting an information communication strategy based, at least in part, on one or more communication quality goals. Accordingly, the scope of various aspects of the present invention should not be limited by characteristics of a particular quality goal, manner of determining a quality goal, or manner of utilizing a quality goal to select an information communication strategy.

Further for example, step 140 may comprise selecting an information communication strategy based, at least in part, on one or more user commands. Such a user command may, for example, be stored in memory or acquired from a user in real-time. In an exemplary scenario, step 140 may comprise accessing stored information communication strategy preference information (e.g., a prioritized list) and selecting an information communication strategy based, at least in part, on such preference information. In another exemplary scenario, step 140 may comprise presenting a list of information communication options or a list of the identified information communication strategies to a user, soliciting input from the user, and selecting an information communication strategy based, at least in part, on the user input.

In general, step 140 may comprise selecting an information communication strategy based, at least in part, on one or more user commands. Accordingly, the scope of various aspects of the present invention should not be limited by characteristics of a particular user command, manner of acquiring or determining a user command, or manner of utilizing a user command to select an information communication strategy.

Step 140 may also, for example, comprise selecting an information communication strategy to utilize to communicate information based, at least in part, on communication environment conditions. Such communication environment conditions may, for example and without limitation, comprise present amount of network traffic, available communication bandwidth, noise, weather effects, network operational status, generally communication network constraints, etc.

For example and without limitation, step 120 may have identified a particular information communication strategy as being available, but the particular information communication strategy may comprise communicating information in a communication environment that is presently experiencing difficulties (e.g., failures or high noise). Step 140 may comprise determining such communication environment conditions, for example, by communicating test information through the communication environment or listening to other entities communicating in the communication environment.

Also for example, step 140 may comprise selecting an information communication strategy based, at least in part, on operating mode of various communication systems. For example, various communication systems may be operating in relatively high performance, low performance, power-save and/or sleep modes. Step 140 may comprise determining operating mode information corresponding to various communication systems and utilizing such information to select an information communication strategy. In a non-limiting exemplary scenario, step 140 may comprise determining that a communication system with which communication is desired is presently operating in a low power, stand-by or sleep mode. In such an exemplary scenario, utilizing a communication strategy having features designed to communicate real-time high-fidelity information may be unnecessarily wasteful of energy or other resources. Thus, in the exemplary scenario, step 140 may comprise selecting a relatively low-data rate connectionless communication strategy, which is relatively energy-efficient.

Further for example, step 140 may comprise selecting an information communication strategy based, at least in part, on operating cost. For example, various information communication strategies may comprise utilizing communication resources having respective monetary costs. In an exemplary scenario, a first information communication strategy (e.g., utilizing a connectionless communication protocol) may comprise a relatively low operating cost, and a second information communication strategy (e.g., utilizing a connection-oriented communication protocol) may comprise a relatively high operating cost. In another exemplary scenario, a first information communication strategy (e.g., communicating non-compressed video information) may comprise a relatively high operating cost (e.g., due to increased bandwidth needs), and a second information communication strategy (e.g., communicating compressed video information) may comprise a relatively low operating cost.

Still further for example, step 140 may comprise selecting an information communication strategy based, at least in part, on power supply (or energy supply) characteristics. Such power supply characteristics may comprise power supply characteristics associated with one or more communicating entities. For example and without limitation, power supply characteristics may comprise information regarding communication system power (or energy) availability. In an exemplary scenario, a first information communication strategy may comprise utilizing a relatively low amount of energy to provide relatively low quality communications, and a second information communication strategy may comprise utilizing a relatively large amount of energy to provide relatively high quality communications. In an exemplary scenario, where under normal power supply conditions the second information communication strategy may be selected, step 140 may comprise selecting the first information communication strategy due to a relatively low amount of energy available to a communicating system. Note that step 140 may comprise selecting an information communication strategy based on power supply characteristics of a system implementing the exemplary method 100 or another system.

Also for example, step 140 may comprise selecting an information communication strategy based, at least in part, on the type of information being communicated. For example and without limitation, various types of information may comprise audio information, video information, textual information, graphical information, pictorial information, data information, etc. Various type of information may correspond to different respective communication needs (e.g., quality goals).

In an exemplary scenario a first information communication strategy may comprise capability to communicate any information, and a second information communication strategy may comprise characteristics particularly designed to communicate textual information. Step 140 may, in the exemplary scenario, comprise selecting the second information communication strategy to communicate a text message. In another exemplary scenario, a first information communication strategy may be capable communicating video information at high resolution, and a second information communication strategy may be capable of communicating video information at low resolution. Step 140 may, in the exemplary scenario, select the second information communication strategy due to a relatively low priority associated with video information communication.

As mentioned previously, step 140 may, for example, comprise determining various selection criteria by communicating with other systems. Step 140 may also, for example, comprise selecting an information communication strategy based, at least in part, on negotiations between various communicating systems. Various communicating systems may have respective operating requirements and conditions.

In an exemplary scenario, a first information communication strategy may normally be the strategy of choice, but a second communicating system may have severely limited energy resources. In the exemplary scenario, step 140 may comprise selecting a second information communication strategy due to the needs of the second communication system. In another exemplary scenario, a first information communication strategy may be preferable for a higher priority communication system, and a second information communication strategy may be preferable for a lower priority communication system. Step 140 may, in the exemplary scenario, comprise selecting the first information communication strategy because of the preference of the higher priority system. In yet another exemplary scenario, a first information communication strategy may be preferable for a communication system implementing the method 100, and a second information communication strategy may be preferable for another system. Step 140 may, in the exemplary scenario, comprise selecting a third communication strategy as a compromise between preferences of the communication systems.

In general, step 140 may comprise selecting an information communication strategy (e.g., of those determined at step 120) to utilize to communicate information (e.g., a unit of information) based, at least in part, on the estimated respective amounts of energy (e.g., as determined at step 130) associated with one or more of the information communication strategies. The previous examples are merely illustrative and, by no means, meant to represent an exclusive set of examples. Accordingly, the scope of various aspects of the present invention should not be limited by characteristics of particular energy-based communication strategy selection techniques.

The exemplary method 100 may, at step 150, comprise performing continued processing. Step 150 may comprise performing any of a large variety of continued processing. For example and without limitation, step 150 may comprise directing execution flow of the method 100 back to previous steps (e.g., step 120). Also for example, step 150 may comprise communicating information utilizing the information communication strategy selected at step 140. Further for example, step 150 may comprise interfacing with various communication systems (e.g., during communications) to determine whether a different communication strategy should be selected. Accordingly, the scope of various aspects of the present invention should not be limited by characteristics of particular continued processing.

The exemplary method 100 was illustrated and discussed to provide illustrative examples of generally broader aspects of the present invention. Accordingly, the scope of various aspects of the present invention should, by no means, be limited to characteristics of the exemplary method 100.

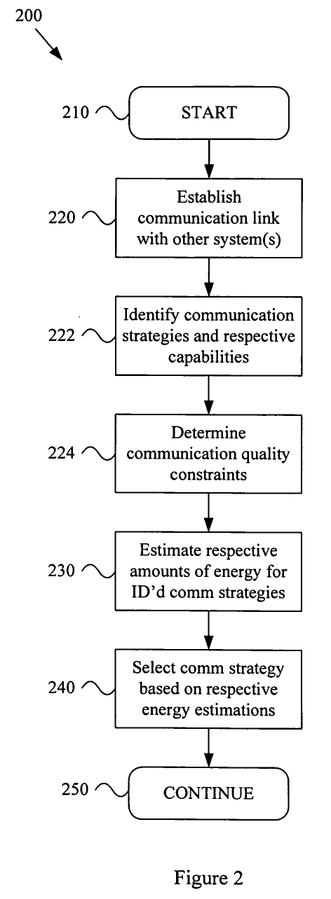

FIG. 2 shows a flow diagram of an exemplary method 200 for determining an information communication strategy, in accordance with various aspects of the present invention. The exemplary method 200 may, for example and without limitation, share various characteristics with the exemplary method 100 illustrated in FIG. 1 and discussed previously. As with the exemplary method 100 illustrated in FIG. 1, the exemplary method 200 may, for example and without limitation, be implemented in a communication system.

The exemplary method 200 may, at step 220, comprise establishing one or more communication links with one or more other systems. Such a communication link may comprise characteristics of any of a variety of communication links. For example, step 220 may comprise establishing the communication link utilizing any of a variety of communication media, protocols or networks. The scope of various aspects of the present invention should not be limited by characteristics of any particular communication link or manner of establishing such a communication link.

The exemplary method 200 may, at step 222, comprise identifying information communication strategies and/or communication capabilities of other communication systems. Exemplary step 222 may, for example and without limitation, share various characteristics with step 120 of the exemplary method 100 illustrated in FIG. 1 and discussed previously.

For example, step 222 may comprise communicating with one or more communication systems to determine which information communication strategies may be utilized for communication with such systems. Also for example, step 222 may comprise communicating with an information database to determine which information communication strategies may be utilized for communication with various systems.

Step 222 may, for example, comprise communicating any of a variety of communication capability information. For example, such information may comprise information regarding communication media, protocols, encoding/decoding capabilities, secure access capabilities, encryption/decryption capabilities, compression/decompression capabilities, data rate capabilities, various signal processing capabilities, etc.

Step 222 may, for example, comprise processing such information to determine a plurality of information communication strategies that may be utilized to communicate information between various communication systems. Also for example, step 222 may comprise processing information related to the capabilities of the communication system(s) implementing the method 200. Characteristics of various information communication strategies were generally discussed previously.

The exemplary method 200 may, at step 224, comprise determining communication quality constraints (e.g., quality goals and/or requirements). Such communication quality constraints were generally discussed previously. For example and without limitation, such communication quality constraints may comprise characteristics related to information transfer speed, error rate, amount of noise, general reliability, data accuracy, data resolution, etc. Step 224 may, for example, comprise communicating information regarding quality constraints with other communication systems. Step 224 may also, for example, comprise communicating information regarding quality constraints with a database comprising such information.

The exemplary method 200 may, at step 230, comprise estimating respective amounts of energy for information communication strategies (e.g., the information communication strategies identified at step 222). Step 230 may, for example and without limitation, share various characteristics with step 130 of the exemplary method 100 illustrated in FIG. 1 and discussed previously.

The exemplary method 200 may, at step 240, comprise selecting an information communication strategy based, at least in part, on the energy estimations determined at step 230. Step 240 may also, for example, comprise selecting an information communication strategy based, at least in part, on the energy estimations determined at step 230 and the communication quality constraints determined at step 224. Step 240 may, for example and without limitation, share various characteristics with step 140 of the exemplary method 100 illustrated in FIG. 1 and discussed previously.

The exemplary method 200 was illustrated and discussed to provide illustrative examples of generally broader aspects of the present invention. Accordingly, the scope of various aspects of the present invention should, by no means, be limited to characteristics of the exemplary method 200.

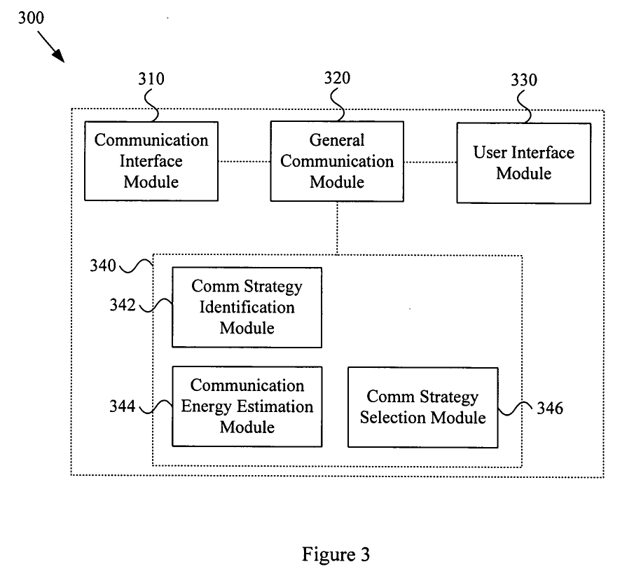

FIG. 3 is a drawing showing a block diagram of an exemplary communication system 300 for determining an information communication strategy, in accordance with various aspects of the present invention. For example and without limitation, the functionality performed by components of the exemplary communication system 300 may share various characteristics with the exemplary methods 100, 200 illustrated in FIGS. 1-2 and discussed previously.

The exemplary communication system 300 may comprise a communication interface module 310. The communication interface module 310 may comprise characteristics of any of a variety of communication interfaces. For example, the communication interface module 310 may be adapted (i.e., comprise hardware and/or software) to communicate over any of a variety of communication networks (e.g., telecommunication, computer, television, satellite, terrestrial, etc.). Also for example, the communication interface module 310 may be adapted to communicate over any of a variety of communication media (e.g., wired, wireless RF, tethered optical, non-tethered optical, etc.). Also, the communication interface module 310 may be adapted to communicate utilizing any of a variety of communication standards and/or protocols. In addition, the communication interface module 310 may be adapted to communicate utilizing any of a variety of encoding schemes, compression schemes, encryption schemes, secure access protocols, etc. Accordingly, the scope of various aspects of the present invention should not be limited by characteristics of any particular communication interface.

The exemplary communication system 300 may comprise a general communication module 320. The general communication module 320 may, for example, manage or support general communication activities performed by the communication system 300. In a non-limiting exemplary scenario where the communication system 300 comprises characteristics of a cellular phone, the general communication module 320 may perform various communication management tasks associated with cellular telephony. In another non-limiting exemplary scenario where the communication system 300 comprises characteristics of an Internet communication system, the general communication module 320 may perform various communication management tasks associated with Internet communications. In yet another non-limiting exemplary scenario where the communication system 300 comprises characteristics of a wireless PAN communication system, the general communication module 320 may perform various communication management tasks associated with wireless PAN communications.

In general, the general communication module 320 may generally manage or support various aspects of communications, which may depend on the nature of the communication system 300. Accordingly, the scope of various aspects of the present invention should not be limited by characteristics of any particular general communications management or support hardware and/or software.

The exemplary communication system 300 may comprise a user interface module 330. The user interface module 330 may generally comprise hardware and/or software that provide an interface between a user and the communication system 300. The user interface module 330 may be adapted to provide any of large variety of user interface types (e.g., text-based, video-based, audio-based, touch-based, etc.). Accordingly, the scope of various aspects of the present invention should not be limited by characteristics of any particular user interface hardware and/or software.

The exemplary communication system 300 may comprise a system 340 that determines an information communication strategy. The exemplary system 340 may comprise a communication strategy identification module 342, a communication energy estimation module 344 and a communication strategy selection module 346.

The following discussion may generally refer to various modules. It must be recognized that the various modules may be implemented utilizing hardware, software and combinations thereof. Also, various modules may share components with various other modules. For example, a first module may share one or more hardware components (e.g., a processor, memory, etc.) with a second module. Also for example, a first module may share various software routines with a second module. Various modules may, for example, be integrated to any of a variety of degrees of integration. For example, various modules may be integrated into a single integrated circuit, separate integrated circuits on a board, or may be geographically collocated or geographically distributed. Accordingly, the scope of various aspects of the present invention should not be limited by characteristics of any particular hardware and/or software implementation of a module or any arbitrary boundary between modules.

The communication strategy identification module 342 (“CSI module 342”) may identify a plurality of information communication strategies that may be utilized to communicate information (e.g., one or more units of information). The CSI module 342 may, for example and without limitation, share various functional characteristics with step 120 of the exemplary method 100 illustrated in FIG. 1 and discussed previously.

As discussed previously with regard to FIG. 1, an information communication strategy may comprise any of any of a large variety of information communication strategy characteristics. For example and without limitation, one of more (e.g., a first portion) of the identified plurality of information communication strategies may comprise a connectionless communication strategy, and one or more (e.g., a second portion) of the identified plurality of information communication strategies may comprise a connection-oriented communication strategy. Also for example, one or more of the identified plurality of information communication strategies may comprise communicating information at a first data rate, and one or more of the identified plurality of information communication strategies may comprise communicating information at a second data rate.

Further for example, one or more of the identified plurality of information communication strategies may comprise transmitting information at a first transmission power, and a second portion of the identified plurality of information communication strategies may comprise transmitting information at a second transmission power. Also for example, one or more of the identified plurality of information communication strategies may comprise communicating information over a first communication medium, and one or more of the identified plurality of information communication strategies may comprise communicating information over a second communication medium.

Still further for example, one or more of the identified plurality of information communication strategies may comprise modulating information utilizing a first type of modulation, and one or more of the identified plurality of information communication strategies may comprise modulating information utilizing a second type of modulation. Also for example, one or more of the identified plurality of information communication strategies may comprise communicating information utilizing a first communication protocol, and one or more of the identified plurality of information communication strategies may comprise communicating information utilizing a second communication protocol.

Still further for example, one or more of the identified plurality of information communication strategies may comprise utilizing a first communication standard, and one or more of the identified plurality of information communication strategies may comprise utilizing a second communication standard. For example, one or more of the identified plurality of information communication strategies may comprise communicating information utilizing a first number of antennas, and one or more of the identified plurality of information communication strategies may comprise communicating information utilizing a second number of antennas.

Also for example, one or more of the identified plurality of information communication strategies may comprise encoding information utilizing a first type of encoding, and one or more of the identified plurality of information communication strategies may comprise encoding information utilizing a second type of encoding. Further for example, one or more of the plurality of information communication strategies may comprise utilizing a first type of secure communication technique, and one or more of the identified plurality of information communication strategies may comprise utilizing a second type of secure communication technique. Still further for example, one or more of the plurality of information communication strategies may comprise utilizing a first type of information compression technique, and one of more of the identified plurality of information communication strategies may comprise utilizing a second type of information compression technique.

It should be noted that the previously discussed exemplary characteristics of various information communication strategies represent a non-limiting illustrative set of such characteristics. Accordingly, the scope of various aspects of the present invention should not be limited by characteristics of any particular communication strategy, including those discussed above and those not discussed above.

As mentioned previously, the CSI module 342 may identify a plurality of information communication strategies that may be utilized to communicate information (e.g., one or more units of information). The CSI module 342 may identify a plurality of information communication strategies in any of a variety of manners.

For example and without limitation, the CSI module 342 may communicate (e.g., utilizing the communication interface module 310) with one or more other communication systems regarding respective communication capabilities of the various communication systems. In a non-limiting exemplary scenario, the CSI module 342 may communicate with a second communication system to determine the communication capabilities of the second communication system, and vice versa. Such communication may, for example and without limitation, comprise communicating information of any of the various communication characteristics discussed previously. For example, the CSI module 342 may communicate with the second communication system to determine information related to data communication rate, error rate, transmission and/or reception power, communication protocols, antenna number, encoding/decoding capability, communication medium access, modulation/demodulation capability, secure communication capability, various signal processing capabilities, etc.

Also for example, the CSI module 342 may communicate with a database (e.g., internal to the communication system 300 or external to the communication system 300) that comprises information related to the communication capabilities of various communication systems. Such a database may, for example, comprise relatively static information of communication system capability or may, for example, comprise dynamically updated information of communication system capability. For example, such dynamically updated information may comprise information related to current communication network operational status and/or connectivity.

Also for example, the CSI module 342 may test for various communication capabilities. In a non-limiting exemplary scenario, the CSI module 342 may attempt to communicate (e.g., utilizing the communication interface module 310) using a variety of communication techniques to determine which communication techniques are effective. For example, the CSI module 342 may, through interaction with a second communication system or database having information related to the second communication, determine that the second communication system comprises capability to communicate using a particular set of communication protocols, modulation methods and secure communication techniques. The CSI module 342 may, in such an exemplary scenario, attempt to communicate with the second communication system utilizing any or all of the set of communication protocols, modulation methods and secure communication techniques to determine whether each is presently available.

In a non-limiting exemplary scenario, the CSI module 342 may determine that the second communication system should be capable of communicating information utilizing the IEEE 802.11 and IEEE 802.16 communication standards. The CSI module 342 may then attempt to communicate with the second system utilizing the IEEE 802.11 and 802.16 standards to determine if an information communication strategy incorporating one or both of such standards is presently feasible.

In another non-limiting exemplary scenario, the CSI module 342 may determine that the second communication system should be capable of communicating utilizing MIMO communication. The CSI module 342 may then attempt to communicate with the second communication system utilizing MIMO communication to determine if an information communication strategy utilizing MIMO communication is presently viable.

In yet another non-limiting exemplary scenario, the CSI module 342 may determine that the second system should be capable of communicating information over the Internet at a particular minimum data rate. The CSI module 342 may then attempt to establish an Internet communication link with the second communication system and communicate data at the particular minimum data rate to determine if an information communication strategy utilizing Internet communication at the minimum data rate is currently feasible.

In general, the CSI module 342 may identify a plurality of information communication strategies that may be utilized to communicate information. Accordingly, the scope of various aspects of the present invention should not be limited by characteristics of any particular manner of identifying a particular information communication strategy or of any particular hardware and/or software for making such identification.

The communication energy estimation module 344 (“CEE module 344”) may estimate respective amounts of energy for a least a portion of a plurality of information communication strategies (e.g., as identified by the CSI module 342). The CEE module 344 may, for example and without limitation, share various functional characteristics with step 130 of the exemplary method 100 illustrated in FIG. 1 and discussed previously. The CEE module 344 may estimate respective amounts of energy for various information communication strategies in any of a variety of manners.

For example and without limitation, the CEE module 344 may estimate respective amounts of energy for at least a portion of the identified plurality of information communication strategies based at least in part on transmission power. For example, various information communication strategies may utilize a transmitter to transmit information, where the transmitter utilizes a non-negligible amount of electrical power to transmit the information. Additionally, various information communication strategies may comprise transmitting information at different power levels. The CEE module 344 may, in various scenarios, also estimate respective amounts of energy for at least a portion of the identified plurality of information communication strategies based at least in part on reception power. For example, in various scenarios different information communication strategies may comprise utilization of different respective amounts of electrical power in signal reception circuitry.

Also for example, the CEE module 344 may estimate respective amounts of energy for at least a portion of the identified plurality of information communication strategies based, at least in part, on signal processing energy (or power). For example, different communication strategies may require different respective amounts of signal processing, which may correspond to different amounts of electrical energy. Further for example, the CEE module 344 may estimate respective amounts of energy for at least a portion of the identified plurality of information communication strategies based, at least in part, on energy required to retransmit information. For example, various information communication strategies may comprise retransmitting different respective amounts of information.

Additionally for example, the CEE module 344 may estimate respective amounts of energy for at least a portion of the identified plurality of information communication strategies based at least in part on energy required to re-process retransmitted information. For example, as mentioned previously, various information communication strategies may comprise retransmitting at least a portion of transmitted information. Such retransmitted information may correspond to additional signal processing (e.g., at the transmitting system and/or receiving system). Such signal processing may, for example and without limitation, comprise re-encoding/decoding, re-compressing/decompressing, re-encrypting/decrypting, etc.

The CEE module 344 may, for example, estimate respective amounts of energy to communicate information for one or more of the plurality of information communication strategies. The CEE module 344 may, for example and without limitation, estimate respective amounts of energy utilizing any one or combination of the above-mentioned energy considerations. Further, since the above-mentioned energy considerations are merely exemplary, the CEE module 344 may utilize any other communication-related energy considerations that were not discussed previously.

In general, the CEE module 344 may estimate respective amounts of energy to communicate information (e.g., one or more units of information) for at least a portion of the identified plurality of information communication strategies (e.g., as identified by the CSI module 342). Accordingly, the scope of various aspects of the present invention should not be limited by characteristics of any particular manner of estimating energy that may be utilized to communicate information or by characteristics of any particular hardware and/or software for performing such energy estimation.

The communication strategy selection module 346 (“CSS module 346”) may select an information communication strategy from a plurality of information communication strategies (e.g., at least a portion of the communication strategies identified by the CSI module 342 and for which the CEE module 344 estimated communication energy). The CSS module 346 may, for example and without limitation, share various functional characteristics with step 140 of the exemplary method 100 illustrated in FIG. 1 and discussed previously. The CSS module 346 may select an information communication strategy in any of a variety of manners, non-limiting illustrative examples of which are provided below.

The CSS module 346 may, for example, select an information communication strategy by selecting an information communication strategy with the lowest respective estimated amount of energy. Various information communication strategies may, for example, comprise utilizing different respective amounts of energy to communicate information. Also for example, the CSS module 346 may select an information communication strategy by selecting an information communication strategy based, at least in part, on one or more communication quality goals. Communication quality goals were generally discussed previously in the discussion of FIG. 1.

The CSS module 346 may, for example, determine communication quality goals in any of a variety of manners. For example and without limitation, the CSS module 346 may utilize predetermined quality goals (e.g., stored in local memory of the system 300 or a communicatively coupled database). Also for example, the CSS module 346 may communicate with other communication systems (e.g., utilizing the communication interface module 310) to determine quality goals. Further for example, the CSS module 346 may communicate with a user (e.g., utilizing the user interface module 330) to determine quality goals.

In an exemplary scenario, the CSS module 346 may select an information communication strategy that utilizes the least amount of energy while meeting minimum quality goals. In another exemplary scenario, the CSS module 346 may select an information communication strategy that provides a desired balance between energy consumption and quality. In general, the CSS module 346 may select an information communication strategy based, at least in part, on one or more communication quality goals. Accordingly, the scope of various aspects of the present invention should not be limited by characteristics of a particular quality goal, manner of determining a quality goal, manner of utilizing a quality goal to select an information communication strategy, or related hardware and/or software.

Further for example, the CSS module 346 may select an information communication strategy based, at least in part, on one or more user commands. Such a user command may, for example, be stored in memory or acquired from a user in real-time. In an exemplary scenario, the CSS module 346 may access stored communication strategy preference information (e.g., a prioritized list) and select an information communication strategy based, at least in part, on such preference information. In another exemplary scenario, the CSS module 346 may present a list of information communication options or a list of the identified information communication strategies to a user (e.g., utilizing the user interface module 330), solicit input from the user, and select an information communication strategy based, at least in part, on the user input. The scope of various aspects of the present invention should not be limited by characteristics of a particular user command, manner of acquiring or determining a user command, manner of utilizing a user command to select an information communication strategy, or related hardware and/or software.

The CSS module 346 may also, for example, select an information communication strategy to utilize to communicate information based, at least in part, on communication environment conditions. Such communication environment conditions may, for example and without limitation, comprise present amount of network traffic, available communication bandwidth, noise, weather effects, network operational status, general communication network constraints, etc.

For example and without limitation, the CSI module 342 may have identified a particular communication strategy as being available, but the particular communication strategy may comprise communicating information in a communication environment that is presently experiencing difficulties (e.g., failures or high noise). The CSS module 346 may determine such communication environment conditions, for example, by communicating test information through the communication environment or listening to other entities communicating in the communication environment.

Also for example, the CSS module 346 may select an information communication strategy based, at least in part, on operating mode of various communication systems. For example, various communication systems may be operating in relatively high performance, low performance, power-save and/or sleep modes. The CSS module 346 may determine operating mode information corresponding to various communication systems and utilize such information to select an information communication strategy. In a non-limiting exemplary scenario, the CSS module 346 may determine that a communication system with which communication is desired is presently operating in a low power, stand-by or sleep mode. In such an exemplary scenario, utilizing a communication strategy having features designed to communicate real-time high-fidelity information may be unnecessarily wasteful of energy or other resources. Thus, in the exemplary scenario, the CSS module 346 may select a relatively low-data rate connectionless communication strategy, which is relatively energy-efficient.

Further for example, the CSS module 346 may select an information communication strategy based, at least in part, on operating cost. For example, various information communication strategies may comprise utilizing communication resources having respective monetary costs. Still further for example, the CSS module 346 may comprise selecting an information communication strategy based, at least in part, on power supply (or energy supply) characteristics. Such power supply characteristics may comprise power supply characteristics associated with one or more communicating systems. Such power supply characteristics were generally discussed previously in the discussion of FIG. 1.

The CSS module 346 may, for example, select an information communication strategy based, at least in part, on the type of information being communicated. For example and without limitation, various types of information may comprise audio information, video information, textual information, graphical information, pictorial information, data information, etc. Various types of information may, for example, correspond to different respective communication needs (e.g., communication quality goals).

As mentioned previously, the CSS module 346 may, for example, determine various selection criteria by communicating with other systems. The CSS module 346 may also, for example, select an information communication strategy based, at least in part, on negotiations between various communicating systems. Various communicating systems may have respective operating requirements and conditions.

In an exemplary scenario, a first information communication strategy may normally be the strategy of choice, but a second communicating system may have severely limited energy resources. In the exemplary scenario, the CSS module 346 may select a second information communication strategy due to the needs of the second communication system. In another exemplary scenario, a first information communication strategy may be preferable for a higher priority communication system, and a second information communication strategy may be preferable for a lower priority communication system. The CSS module 346 may, in the exemplary scenario, select the first information communication strategy because of the preference of the higher priority system. In yet another exemplary scenario, a first information communication strategy may be preferable for the communication system 300, and a second information communication strategy may be preferable for another communication system. The CSS module 346 may, in the exemplary scenario, select a third communication strategy as a compromise between preferences of the communication systems.

In general, the CSS module 346 may select an information communication strategy (e.g., of a plurality of information communication strategies identified by the CSI module 342) to utilize to communicate information (e.g., one or more units of information) based, at least in part, on estimated respective amounts of energy (e.g., as determined by the CEE module 344) associated with one or more of the communication strategies. The previous examples are merely illustrative and, by no means, meant to represent an exclusive set of examples. Accordingly, the scope of various aspects of the present invention should not be limited by characteristics of particular energy-based communication strategy selection techniques or by particular hardware and/or software for making such selection.

The exemplary system 300 was illustrated and discussed to provide illustrative examples of generally broader aspects of the present invention. Accordingly, the scope of various aspects of the present invention should, by no means, be limited to characteristics of the exemplary system 300.

As mentioned previously, and as stressed here again, in the exemplary system 300, the various modules may, for example and without limitation, be implemented in hardware, software or a combination thereof. Further, the various modules may each comprise a set of discrete components, may each be independent integrated circuits, or may each be a portion of an integrated circuit. Still further, the various modules may be located at one geographical location or distributed between multiple geographical locations. By no means should the scope of various aspects of the present invention be limited by characteristics of particular implementations or locations of various modules.

It should be noted that the previously presented exemplary system 300 and methods 100, 200 were provided to show specific examples of generally broader aspects of the present invention. Accordingly, the scope of various aspects of the present invention should not be limited by characteristics of particular examples presented herein.

In summary, various aspects of the present invention provide a system and method for determining an information communication strategy based on energy requirements. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. In a communication system, a method for determining an information communication strategy, the method comprising:
identifying a plurality of information communication strategies that may be utilized to communicate information with at least a second communication system;
estimating respective amounts of energy to communicate the information for at least a portion of the identified plurality of information communication strategies; and
selecting an information communication strategy from the identified plurality of information communication strategies based, at least in part, on the estimated respective amounts of energy.

2. The method of claim 1, wherein identifying a plurality of information communication strategies comprises communicating information regarding communication capabilities with at least one of: the second communication system and a database comprising information regarding the second computer system.

3. The method of claim 1, wherein a first portion of the identified plurality of information communication strategies comprises communicating information at a first data rate, and a second portion of the identified plurality of information communication strategies comprises communicating information at a second data rate.

4. The method of claim 1, wherein a first portion of the identified plurality of information communication strategies comprises transmitting information at a first transmission power, and a second portion of the identified plurality of information communication strategies comprises transmitting information at a second transmission power.

5. The method of claim 1, wherein a first portion of the identified plurality of information communication strategies comprises communicating information utilizing a first communication protocol, and a second portion of the identified plurality of information communication strategies comprises communicating information utilizing a second communication protocol.

6. The method of claim 1, wherein a first portion of the identified plurality of information communication strategies comprises communicating information utilizing a first number of antennas, and a second portion of the identified plurality of information communication strategies comprises communicating information utilizing a second number of antennas.

7. The method of claim 1, wherein a first portion of the identified plurality of information communication strategies comprises encoding information utilizing a first type of encoding, and a second portion of the identified plurality of information communication strategies comprises encoding information utilizing a second type of encoding.

8. The method of claim 1, wherein estimating respective amounts of energy for at least a portion of the identified plurality of information communication strategies comprises estimating respective amounts of energy for at least a portion of the identified plurality of information communication strategies based, at least in part, on transmission power.

9. The method of claim 1, wherein estimating respective amounts of energy for at least a portion of the identified plurality of information communication strategies comprises estimating respective amounts of energy for at least a portion of the identified plurality of information communication strategies based, at least in part, on signal processing power.

10. The method of claim 1, wherein selecting an information communication strategy comprises selecting an information communication strategy with the lowest estimated respective amount of energy.

11. The method of claim 1, wherein selecting an information communication strategy comprises selecting an information communication strategy based, at least in part, on one or more communication quality goals.

12. The method of claim 1, wherein selecting an information communication strategy comprises selecting an information communication strategy based, at least in part, on a user command.

13. The method of claim 1, wherein selecting an information communication strategy comprises selecting an information communication strategy based, at least in part, on communication environment conditions.

14. The method of claim 1, wherein selecting an information communication strategy comprises selecting an information communication strategy based, at least in part, on operating cost.

15. The method of claim 1, wherein selecting an information communication strategy comprises selecting an information communication strategy based, at least in part, on power supply characteristics of at least one of: the communication system and the second communication system.

16. The method of claim 1, wherein selecting an information communication strategy comprises selecting an information communication strategy based, at least in part, on type of information being communicated.

17. The method of claim 1, wherein selecting an information communication strategy comprises selecting an order of a MIMO communication strategy based, at least in part, on transmission energy associated with each of a plurality of potential MIMO orders.

18. In a communication system, a system that determines an information communication strategy, the system comprising:
at least one module that identifies a plurality of information communication strategies that may be utilized to communicate information with at least a second communication system;
at least one module that estimates respective amounts of energy to communicate the information for at least a portion of the identified plurality of information communication strategies; and
at least one module that selects an information communication strategy from the identified plurality of information communication strategies based, at least in part, on the estimated respective amounts of energy.

19. The system of claim 18, wherein the at least one module comprises:
a communication strategy identification module;
a communication energy estimation module; and
a communication strategy selection module.

20. The system of claim 18, wherein the at least one module identifies a plurality of information communication strategies by, at least in part, communicating information regarding communication capabilities with at least one of: the second communication system and a database comprising information regarding the second communication system.

21. The system of claim 18, wherein a first portion of the identified plurality of information communication strategies comprises communicating information at a first data rate, and a second portion of the identified plurality of information communication strategies comprises communicating information at a second data rate.

22. The system of claim 18, wherein a first portion of the identified plurality of information communication strategies comprises transmitting information at a first transmission power, and a second portion of the identified plurality of information communication strategies comprises transmitting information at a second transmission power.

23. The system of claim 18, wherein a first portion of the identified plurality of information communication strategies comprises communicating information utilizing a first communication protocol, and a second portion of the identified plurality of information communication strategies comprises communicating information utilizing a second communication protocol.

24. The system of claim 18, wherein a first portion of the identified plurality of information communication strategies comprises communicating information utilizing a first number of antennas, and a second portion of the identified plurality of information communication strategies comprises communicating information utilizing a second number of antennas.

25. The system of claim 18, wherein a first portion of the identified plurality of information communication strategies comprises encoding information utilizing a first type of encoding, and a second portion of the identified plurality of information communication strategies comprises encoding information utilizing a second type of encoding.

26. The system of claim 18, wherein the at least one module estimates respective amounts of energy for at least a portion of the identified plurality of information communication strategies by estimating respective amounts of energy for at least a portion of the identified plurality of information communication strategies based, at least in part, on transmission power.

27. The system of claim 18, wherein the at least one module estimates respective amounts of energy for at least a portion of the identified plurality of information communication strategies by estimating respective amounts of energy for at least a portion of the identified plurality of information communication strategies based, at least in part, on signal processing power.

28. The system of claim 18, wherein the at least one module selects an information communication strategy by selecting an information communication strategy with the lowest estimated respective amount of energy.

29. The system of claim 18, wherein the at least one module selects an information communication strategy by selecting an information communication strategy based, at least in part, on one or more communication quality goals.

30. The system of claim 18, wherein the at least one module selects an information communication strategy by selecting an information communication strategy based, at least in part, on a user command.

31. The system of claim 18, wherein the at least one module selects an information communication strategy by selecting an information communication strategy based, at least in part, on communication environment conditions.

32. The system of claim 18, wherein the at least one module selects an information communication strategy by selecting an information communication strategy based, at least in part, on operating cost.

33. The system of claim 18, wherein the at least one module selects an information communication strategy by selecting an information communication strategy based, at least in part, on power supply characteristics of at least one of: the communication system and the second communication system.

34. The system of claim 18, wherein the at least one module selects an information communication strategy by selecting an information communication strategy based, at least in part, on type of information being communicated.

35. The system of claim 18, wherein the at least one module selects an information communication strategy by selecting an order of a MIMO information communication strategy based, at least in part, on transmission energy associated with each of a plurality of potential MIMO orders.
